(19) United States
(12) Patent Application Publication
(10) Pub. No.: US 2025/0308206 A1
(43) Pub. Date: Oct. 2, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Su Rin Jo, Hwaseoung-Si (KR); Jong Won Park, Hwaseong-Si (KR)

(21) Appl. No.: 18/919,558

(22) Filed: Oct. 18, 2024

(30) Foreign Application Priority Data
Apr. 1, 2024 (KR) 10-2024-0044345

(51) Int. Cl. G06V 10/764; B60W 50/00; B60W 60/00; G01S 17/931; G06V 10/25; G06V 10/82; G06V 20/58

(52) U.S. Cl. CPC G06V 10/764; B60W 50/00; B60W 60/001; G01S 17/931; G06V 10/25; G06V 10/82; G06V 20/58; B60W 2554/00

(57) ABSTRACT

An apparatus for controlling autonomous driving of a vehicle may comprise a sensor, a memory configured to store a neural network model, and a processor. The processor is configured to obtain a first virtual box based on a cluster of points representing an external object detected by the sensor, and a second virtual box by inputting the cluster of points into the neural network model. The processor initializes second classification information among first and second classification information included in the first virtual box. The processor determines whether to update the second classification information using the second virtual box based on the association between the first and second virtual boxes. The processor then outputs the first virtual box by assigning either the first or second classification information, generates a signal indicating the assigned classification information, and controls the autonomous driving of the vehicle based on the signal.

### CROSS-REFERENCE TO RELATED APPLICATION

This application claims the benefit of priority to Korean Patent Application No. 10-2024-0044345, filed in the Korean Intellectual Property Office on Apr. 1, 2024, the entire contents of which are incorporated herein by reference.

### TECHNICAL FIELD

The present disclosure relates to a vehicle control apparatus and a method thereof, and more particularly, relates to a technology for determining the type of an external object.

### BACKGROUND

The matters described in this Background section are only for enhancement of understanding of the background of the disclosure, and should not be taken as acknowledgement that they correspond to prior art already known to those skilled in the art. Various studies are being conducted to identify an external object by using various sensors to assist the driving of a vehicle.

In particular, while being driving in a driving assistance device activation mode or an autonomous driving mode, the vehicle may identify the external object by using a sensor (e.g., a light detection and ranging (LiDAR)).

If the type (or class) of the external object is determined by using a virtual box based on a point cloud obtained through the LiDAR, various processes may be used. For example, a vehicle control apparatus may create a virtual box by using the point cloud and may determine the type of the external object based on the created virtual box. For another example, the vehicle control apparatus may determine the type of the external object based on a virtual box output from a neural network model by inputting the point cloud into the neural network model.

If the type of the external object is determined based on the contents described above, the type of the external object may be incorrectly determined, and thus there is a need to conduct research on this.

### SUMMARY

According to the present disclosure, an apparatus for controlling autonomous driving of a vehicle, the apparatus may comprise a sensor, a memory configured to store a neural network model, and a processor configured to obtain, based on a cluster of points representing an external object detected by the sensor, a first virtual box, obtain, based on inputting the cluster of points into the neural network model, a second virtual box, initialize second classification information among first classification information and the second classification information, wherein the first classification information and the second classification information are included in the first virtual box, determine, based on whether the first virtual box being associated with the second virtual box, whether to update the second classification information by using the second virtual box, output, based on whether the second classification information being updated, the first virtual box by assigning at least one of the first classification information or the second classification information to the first virtual box, generate a signal indicating at least one of the first classification information or the second classification information assigned to the first virtual box, and control, based on the signal, autonomous driving of the vehicle.

The apparatus, wherein the first classification information comprises at least one of first classes indicating types corresponding to the external object, wherein the external object is determined through the first virtual box, or first reliabilities respectively corresponding to the first classes, and wherein the second classification information comprises at least one of second classes indicating types corresponding to the external object, wherein the external object is determined through the second virtual box, or second reliabilities respectively corresponding to the second classes.

The apparatus, wherein the processor is configured to update, based on determining that the second classification information is to be updated, the second classification information, and output, based on updating the second classification information, the first virtual box by assigning the updated second classification information to the first virtual box.

The apparatus, wherein the processor is configured to output, based on determining that the second classification information is not to be updated by using the second virtual box, the first virtual box by assigning the first classification information to the first virtual box.

The apparatus, wherein the processor is configured to determine whether the first virtual box is associated with the second virtual box, based on at least one of an indication of whether the first virtual box is fused with the second virtual box, an indication of whether a box reliability of the second virtual box satisfies a threshold value, or an indication of whether the first virtual box overlaps the second virtual box and whether an overlap ratio between the first virtual box and the second virtual box satisfies a reference ratio.

The apparatus, wherein the processor is configured to determine that the first virtual box is associated with the second virtual box, based on at least one of the first virtual box being fused with the second virtual box, the box reliability of the second virtual box satisfying the threshold value, or the first virtual box at least partially overlapping the second virtual box and the overlap ratio between the first virtual box and the second virtual box satisfying the reference ratio.

The apparatus, wherein the processor is configured to determine that the first virtual box is not associated with the second virtual box, based on least one of the first virtual box not being fused with the second virtual box, the box reliability of the second virtual box not satisfying the threshold value, the first virtual box not overlapping the second virtual box, or the overlap ratio between the first virtual box and the second virtual box not satisfying the reference ratio, and output, based on the first virtual box not being associated with the second virtual box, the first virtual box by assigning the first classification information to the first virtual box.

The apparatus, wherein the processor is configured to determine, based on dividing a width and a length of the first virtual box at an interval, at least one of whether the first virtual box overlaps the second virtual box, or the overlap ratio between the first virtual box and the second virtual box.

The apparatus, wherein the processor is configured to change, based on a number of times that the first classification information assigned to the first virtual box is changed, in a plurality of frames including a frame including the cluster of points, a first information reliability of the first classification information, and change, based on a number of times that the second classification information assigned to the first virtual box is changed, in the plurality of frames, a second information reliability of the second classification information.

The apparatus, wherein the processor is configured to change, based on a number of times that the first virtual box is associated with the second virtual box, in a plurality of frames including a frame including the cluster of points, at least one of a first information reliability of the first classification information or a second information reliability of the second classification information.

The apparatus, wherein the processor is configured to adjust, based on a plurality of frames including a frame including the cluster of points, at least one of the first reliabilities or the second reliabilities by performing normalization on at least one of the first reliabilities or the second reliabilities.

The apparatus, wherein the processor is configured to determine a weight based on a time point at which a frame is obtained, in a plurality of frames including the frame, wherein the frame comprises the cluster of points, and wherein the weight is to be applied to at least one of the first classification information or the second classification information.

The apparatus, wherein the processor is configured to change, based on a size of the first virtual box, at least one of a first information reliability of the first classification information or a second information reliability of the second classification information.

The apparatus, wherein the processor is configured to obtain, from the cluster of points, at least one of a width, a length, a height, a histogram, or a density of the cluster of points, and obtain, based on at least one of the width, the length, the height, the histogram, or the density, the first virtual box.

According to the present disclosure, a method performed by an apparatus of a vehicle for controlling autonomous driving of the vehicle, the method may comprise obtaining, based on a cluster of points representing an external object detected by a sensor, a first virtual box, obtaining, based on inputting the cluster of points into a neural network model, a second virtual box, initializing second classification information among first classification information and the second classification information, wherein the first classification information and the second classification information are included in the first virtual box, determining, based on whether the first virtual box being associated with the second virtual box, whether to update the second classification information by using the second virtual box, outputting, based on whether the second classification information being updated, the first virtual box by assigning at least one of the first classification information or the second classification information to the first virtual box, generating a signal indicating at least one of the first classification information or the second classification information assigned to the first virtual box, and controlling, based on the signal, autonomous driving of the vehicle.

The method, wherein the first classification information comprises at least one of first classes indicating types corresponding to the external object, wherein the external object is determined through the first virtual box, or first reliabilities respectively corresponding to the first classes, and wherein the second classification information comprises at least one of second classes indicating types corresponding to the external object, wherein the external object is determined through the second virtual box, or second reliabilities respectively corresponding to the second classes.

The method may further comprise updating, based on determining whether the second classification information is to be updated, the second classification information, and performing one of outputting, based on updating the second classification information, the first virtual box by assigning the updated second classification information to the first virtual box, or outputting the first virtual box by assigning the first classification information to the first virtual box.

The method, wherein the outputting the first virtual box by assigning the first classification information to the first virtual box is based on determining that the second classification information is not to be updated by using the second virtual box.

The method may further comprise determining whether the first virtual box is associated with the second virtual box, based on at least one of an indication of whether the first virtual box is fused with the second virtual box, an indication of whether a box reliability of the second virtual box satisfies a threshold value, or an indication of whether the first virtual box overlaps the second virtual box and whether an overlap ratio between the first virtual box and the second virtual box satisfies a reference ratio.

The method may further comprise obtaining, from the cluster of points, at least one of a width, a length, a height, a histogram, or a density of the cluster of points, and obtaining, based on at least one of the width, the length, the height, the histogram, or the density, the first virtual box.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example of a flowchart associated with a vehicle control method, according to an example of the present disclosure;

FIG. 3 shows an example of a flowchart associated with a vehicle control method, according to an example of the present disclosure;

FIG. 4 shows an example of identifying an overlap ratio between a first virtual box and a second virtual box, in an example of the present disclosure;

FIG. 5 shows an example of a flowchart associated with a vehicle control method, according to an example of the present disclosure;

FIG. 6 shows an example of a flowchart associated with a vehicle control method, according to an example of the present disclosure;

FIG. 7 shows an example of identifying a weight applied to classification information by using a plurality of frames, in an example of the present disclosure;

FIG. 8 shows an example of a flowchart associated with a vehicle control method, according to an example of the present disclosure; and

FIG. 9 shows an example of a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

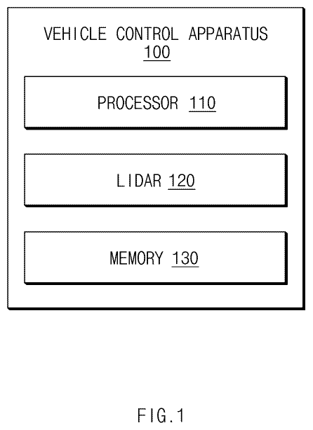

Hereinafter, various examples of the present disclosure will be described in detail with reference to FIGS. 1 to 9.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a LiDAR 120, and a memory 130. The processor 110, the LiDAR 120, or the memory 130 may be electrically and/or operably coupled with each other by an electronical component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The LiDAR 120 included in the vehicle control apparatus 100 according to an example may obtain data sets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or speed of the surrounding object, or any combination thereof based on a pulse laser signal emitted from the LiDAR 120 being reflected by the surrounding object and returned.

For example, the LiDAR 120 may obtain data sets for expressing an external object in the space defined by an x-axis, a y-axis, and a z-axis based on a pulse laser signal reflected from surrounding objects. For example, the LiDAR 120 may obtain data sets including a plurality of points in the space, which is formed by the x-axis, the y-axis, and the z-axis, based on receiving the pulse laser signal at a specified period.

For example, the processor 110 included in the vehicle control apparatus 100 according to an example may emit light from a vehicle by controlling the LiDAR 120. For example, the processor 110 may receive light emitted from the vehicle through the LiDAR 120. For example, the processor 110 may identify at least one of a location, a speed, or a moving direction, or any combination thereof of a surrounding object based on a time required to transmit light emitted from the vehicle and a time required to receive light emitted from the vehicle.

The memory 130 included in the vehicle control apparatus 100 according to an example may include a hardware component for storing data and/or instructions that are to be input and/or output to the processor 110 of the vehicle control apparatus 100.

For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

For example, a neural network model may be stored in the memory 130. For example, the neural network model may include at least one of a multilayer perceptron (MLP), a convolution neural network (CNN), a recurrent neural network (RNN), or a transformer, or any combination thereof. However, an example of the present disclosure is not limited to the above description.

In an example, the processor 110 may obtain a point cloud (e.g., a cluster of data points in space representing a three dimensional shape and size of an object) corresponding to an external object through the LiDAR 120.

For example, the processor 110 may obtain the first virtual box based on at least one of the width, length, or height, or any combination thereof of the point cloud based on obtaining the point cloud corresponding to the external object.

For example, the processor 110 may input the point cloud into the neural network model, which is stored in the memory 130, based on obtaining the point cloud corresponding to the external object. For example, the processor 110 may obtain a second virtual box output from the neural network model based on inputting the point cloud into the neural network model.

For example, the processor 110 may initialize second classification information among first classification information and the second classification information included in the first virtual box.

Classification information may be based on data collected by sensors such as LiDAR and processed through deep learning algorithms. LiDAR sensors may detect objects, which may be represented by a cluster of points (e.g., a point cloud). The cluster of points may be analyzed to classify different objects (e.g., cars, pedestrians, cyclists, and static objects like trees or road signs) in the environment. This classification may help the vehicle understand what objects are present and where they are located. Deep learning models (e.g., convolutional neural networks (CNNs)) may be trained on large datasets to recognize and classify objects within the point cloud data. For example, classification information may refer to the output of these models, which categorize each detected object. For instance, the classification information might classify an object as a “pedestrian,” “car,” “truck,” or “traffic light” based on the features extracted from input data. The classification information may be used for the vehicle's decision-making processes, such as determining whether to stop, slow down, or change lanes.

For example, the first classification information may be referred to as LiDAR signal process (LSP) information.

For example, the second classification information may be referred to as LiDAR deep learning process (LDL) information.

For example, the first classification information may include at least one of first classes indicating types of external objects identified by the first virtual box, or first reliabilities corresponding to each of the first classes, or any combination thereof.

For example, the second classification information may include at least one of second classes indicating types of external objects identified by a second virtual box, or second reliabilities corresponding to each of the second classes, or any combination thereof.

For example, the first classes may include higher categories than the second classes. For example, the first classes may include commercial vehicle (CV), and/or passenger vehicle (PV). The second classes may include a car, a van, and/or a truck. As described above, the first classes may be a category indicating a higher concept than the second classes.

In an example, the processor 110 may determine whether the second classification information is updated, by using the second virtual box based on whether the first virtual box is associated with the second virtual box.

For example, the processor 110 may update the second classification information based on identifying that the second classification information is to be updated by using the second virtual box.

For example, the processor 110 may output the first virtual box by assigning the updated second classification information to the first virtual box based on updating the second classification information.

For example, the processor 110 may update the second classification information by using the second virtual box based on the first virtual box being associated with the second virtual box.

For example, the processor 110 may not update the second classification information based on the first virtual box not being associated with the second virtual box. For example, the processor 110 may output the first virtual box by assigning the first classification information to the first virtual box based on identifying that the second classification information is not to be updated by using the second virtual box.

For example, the processor 110 may determine whether the first virtual box is associated with the second virtual box, based on at least one of a flag associated with whether the first virtual box is fused with the second virtual box, a reliability of the second virtual box, an overlap between the first virtual box and the second virtual box, or an overlap ratio between the first virtual box and the second virtual box, or any combination thereof. For example, if two virtual boxes are “fused,” they may be combined or merged into a single entity. Thus, the boundaries between them may no longer be distinct, and they effectively may become one unified object.

For example, the flag associated with whether the first virtual box is fused with the second virtual box may be referred to as “TargetFlag”.

For example, the processor 110 may determine whether the first virtual box is associated with the second virtual box, based on at least one of whether the flag associated with whether the first virtual box is fused with the second virtual box is true, whether the reliability of the second virtual box exceeds a threshold value, whether the first virtual box overlaps the second virtual box, or whether the overlap ratio between the first virtual box and the second virtual box exceeds a reference ratio, or any combination thereof. For example, if two virtual boxes “overlap,” they may intersect or share some common space, but they may remain distinct entities. Thus, each box may retain its own identity, even though part of one box may lie within the other.

For example, the processor 110 may identify that the first virtual box is associated with the second virtual box, based on the fact that the flag associated with whether the first virtual box is to be fused with the second virtual box is true, the reliability of the second virtual box exceeds the threshold value, the first virtual box at least partially overlaps the second virtual box, and the overlap ratio between the first virtual box and the second virtual box exceeds the reference ratio.

For example, the processor 110 may update the second classification information by using the second virtual box based on identifying that the first virtual box is associated with the second virtual box.

For example, the processor 110 may identify that the first virtual box is not associated with the second virtual box based on the fact that the flag associated with whether the first virtual box is to be fused with the second virtual box is false, the reliability of the second virtual box is smaller than or equal to the threshold value, the first virtual box does not overlap the second virtual box, or the overlap ratio between the first virtual box and the second virtual box is smaller than or equal to the reference ratio.

For example, the processor 110 may not update the second classification information based on the first virtual box not being associated with the second virtual box.

For example, the processor 110 may output the first virtual box by assigning the first classification information to the first virtual box, based on the first virtual box not being associated with the second virtual box.

For example, the processor 110 may identify at least one of whether the first virtual box overlaps the second virtual box, or a ratio at which the first virtual box overlaps the second virtual box, or any combination thereof based on intersection over union (IoU).

IoU is used to evaluate how well a model's predicted bounding boxes (which might represent detected cars, pedestrians, or other objects) match the actual ground truth boxes in the sensor data, particularly in computer vision tasks like autonomous driving. Higher IoU values (e.g., 1: Perfect overlap between the predicted and ground truth boxes, 0: No overlap at all between the predicted and ground truth boxes, 0<IoU<1: Partial overlap, with values closer to 1 indicating better accuracy) indicate better performance of an object detection system. IoU calculation involves Intersection and Union. Intersection is the area where the predicted bounding box (or segmentation mask) overlaps with the ground truth bounding box (or mask). In other words, it is the area of overlap between the two shapes. Union is the total area covered by both the predicted and ground truth bounding boxes (or masks).

For example, the processor 110 may identify at least one of whether the first virtual box overlaps the second virtual box, or a ratio at which the first virtual box overlaps the second virtual box, or any combination thereof based on dividing the width and length of the first virtual box at specified intervals.

For example, the processor 110 may generate a sample region based on dividing the width and length of the first virtual box at specified intervals. The processor 110 may identify at least one of whether the first virtual box overlaps the second virtual box, or a ratio at which the first virtual box overlaps the second virtual box, or any combination thereof based on the second virtual box overlapping the sample region.

In an example, the processor 110 may output the first virtual box by assigning at least one of the first classification information, or the second classification information, or any combination thereof to the first virtual box based on whether the second classification information is updated.

In an example, the processor 110 may identify a plurality of frames including a frame in which a point cloud obtained at a first time point is included. For example, the plurality of frames may include frames, each of which includes the first time point and which are obtained at time points before the first time point.

For example, the processor 110 may perform normalization on at least one of first reliabilities, or second reliabilities, or any combination thereof based on a plurality of frames including a frame in which the point cloud obtained at the first time point is included. For example, the processor 110 may correct at least one of the first reliabilities, or the second reliabilities, or any combination thereof by performing normalization on at least one of the first reliabilities, or the second reliabilities, or any combination thereof based on a plurality of frames including a frame in which the point cloud obtained at the first time point is included.

For example, the plurality of frames may include 5 frames, and/or 20 frames. However, an example of the present disclosure is not limited to the above description.

For example, the processor 110 may identify the number of times that classification information assigned to the first virtual box is changed, in the plurality of frames. For example, the processor 110 may change the reliability for at least one of the first classification information, or the second classification information, or any combination thereof based on the number of times that classification information assigned to the first virtual box is changed, in the plurality of frames.

For example, the processor 110 may change the reliability of at least one of the first classification information, or the second classification information, or any combination thereof in the plurality of frames, based on the number of times that the first virtual box matches the second virtual box. For example, the number of times that the first virtual box matches the second virtual box may include the number of times that classification information assigned to the first virtual box is updated by the second virtual box so as to be changed to the second classification information.

For example, the processor 110 may determine a weight to be applied to at least one of the first classification information, or the second classification information, or any combination thereof in the plurality of frames, based on a time point at which a frame is obtained. For example, the processor 110 may apply a relatively higher weight to a frame obtained at a time point relatively close to the first time point (e.g., a current time point). For example, the processor 110 may obtain a reliability with weight applied to at least one of the first classification information, or the second classification information, or any combination thereof by applying a relatively high weight.

For example, the processor 110 may change the reliability of at least one of the first classification information, or the second classification information, or any combination thereof based on the size of the first virtual box.

For example, the processor 110 may reduce the reliability of at least one of the first classification information, or the second classification information, or any combination thereof based on the fact that the size of the first virtual box is incapable of being measured in a class of an external object included in at least one of the first classification information, or the second classification information, or any combination thereof.

For example, the processor 110 may output a first virtual box by assigning classification information different from classification information with reduced reliability to the first virtual box based on reducing the reliability of at least one of the first classification information, or the second classification information, or any combination thereof.

As mentioned above, the processor 110 of the vehicle control apparatus 100 according to an example may assign and output classification information indicating the type of an external object to the first virtual box by using various processes, thereby relatively accurately identifying the type of an external object. Moreover, the processor 110 of the vehicle control apparatus 100 may assign and output relatively accurate classification information to the first virtual box, thereby improving performance if a vehicle is driven in a driving assistance activation mode or an autonomous driving mode by using the first virtual box.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

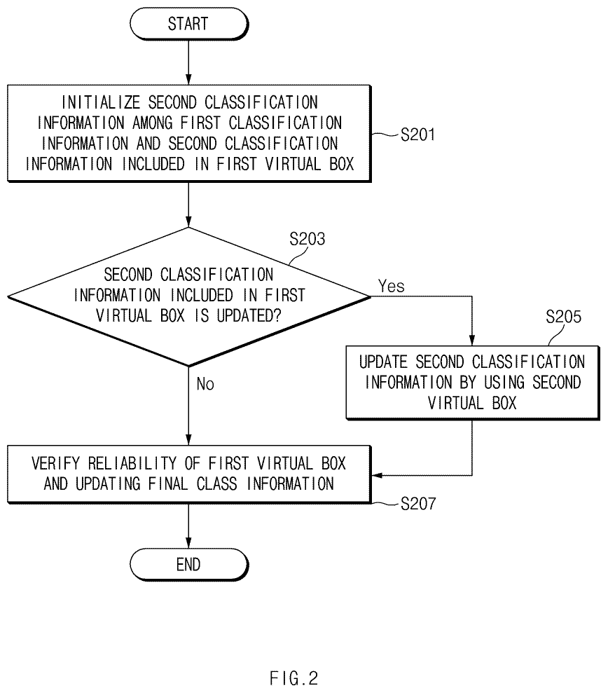

FIG. 2 shows an example of a flowchart associated with a vehicle control method, according to an example of the present disclosure. For convenience, FIG. 2 is described by way of an example in which the steps are performed by a processor (e.g., control circuitry). One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

Hereinafter, it is assumed that the vehicle control apparatus 100 of FIG. 1 performs the process of FIG. 2. In addition or alternative, in a description of FIG. 2, it may be understood that an operation described as being performed by an apparatus is controlled by the processor 110 of the vehicle control apparatus 100.

At least one of operations of FIG. 2 may be performed by the vehicle control apparatus 100 of FIG. 1. At least one of operations of FIG. 2 may be performed by the processor 110 of FIG. 1. Each of the operations in FIG. 2 may be performed sequentially, but is not necessarily sequentially performed. For example, the order of operations may be changed, and at least two operations may be performed in parallel.

Referring to FIG. 2, in S201, a vehicle control method according to an example may include an operation of initializing second classification information among first classification information and the second classification information included in a first virtual box.

For example, the vehicle control method may include an operation of initializing the second classification information to update the second classification information by using a second virtual box different from the first virtual box.

In S203, the vehicle control method according to an example may include an operation of determining whether the second classification information included in the first virtual box is updated.

For example, the vehicle control method may include an operation of determining whether the second classification information included in the first virtual box is updated, based on at least one of whether LSP information obtained from the first virtual box and LDL information obtained from the second virtual box are to be fused, or whether the second virtual box matching the first virtual box is present, or any combination thereof.

In S205, the vehicle control method according to an example may include an operation of updating the second classification information by using the second virtual box.

For example, the vehicle control method may include an operation of changing second classes obtained from the second virtual box to correspond to first classes as well as updating the second classification information by using the second virtual box.

For example, as well as updating the second classification information by using the second virtual box, the vehicle control method may include an operation of updating a flag indicating whether the first virtual box matches the second virtual box so as to be true. For example, a flag indicating whether the first virtual box matches the second virtual box may include “MatchedFlag”.

For example, as well as updating the second classification information by using the second virtual box, the vehicle control method may include an operation of changing information (e.g., fusion age) indicating updating the second classification information. For example, information indicating updating the second classification information may include information for accumulating the number of times that the first virtual box matches the second virtual box.

In S207, the vehicle control method according to an example may include an operation of verifying the reliability of the first virtual box and updating final class information.

For example, the vehicle control method may include an operation of verifying the reliability of classification information assigned to the first virtual box. The reliability of classification information, for example, may be expressed as the percentage of true positive classifications out of all classifications made, Intersection over Union (IoU) values (e.g., higher IoU values indicate more reliable object classification), confidence levels (e.g., classifying an object as a “car” with 95% confidence), error rate (sum of all incorrect classifications as a % of total classifications), etc.

For example, the vehicle control method may include an operation of identifying a frequency at which the type of an external object indicated by the classification information assigned to the first virtual box is changed. For example, if the second virtual box is not present, the vehicle control method may include assigning the type of an external object of the previous frame to the first virtual box by obtaining the type and/or score of the external object of the previous frame from a history.

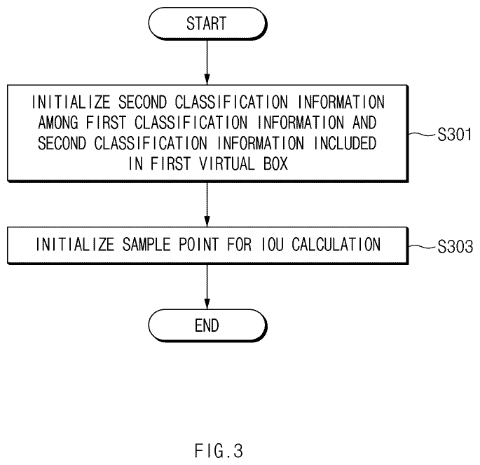

FIG. 3 shows an example of a flowchart associated with a vehicle control method, according to an example of the present disclosure.

Hereinafter, it is assumed that the vehicle control apparatus 100 of FIG. 1 performs the process of FIG. 3. In addition or alternative, in a description of FIG. 3, it may be understood that an operation described as being performed by an apparatus is controlled by the processor 110 of the vehicle control apparatus 100.

At least one of operations of FIG. 3 may be performed by the vehicle control apparatus 100 of FIG. 1. At least one of operations of FIG. 3 may be performed by the processor 110 of FIG. 1. Each of the operations in FIG. 3 may be performed sequentially, but is not necessarily sequentially performed. For example, the order of operations may be changed, and at least two operations may be performed in parallel.

Referring to FIG. 3, in S301, a vehicle control method according to an example may include an operation of initializing second classification information among first classification information and second classification information included in a first virtual box. For example, S301 may be substantially the same as S201 in FIG. 2.

For example, the vehicle control method may include an operation of initializing at least one of information about the type of the external object obtained from a second virtual box included in the second classification information, a flag indicating whether the first virtual box matches the second virtual box, or a flag indicating whether the first virtual box is to be fused with the second virtual box, or any combination thereof.

In S303, the vehicle control method according to an example may include an operation of initializing a sample point for IoU calculation.

For example, the vehicle control method may include an operation of initializing coordinates of the sample point for simplified IoU calculation. For example, the vehicle control method may include an operation of initializing the coordinates of a sample point to (0,0).

For example, the sample point may mean a point divided at equal intervals if the first virtual box is observed from a top-view.

For example, the vehicle control method may include an operation of setting each of regions divided at specified intervals to the sample point based on dividing the first virtual box at specified intervals.

As mentioned above, the vehicle control method may determine whether the first virtual box overlaps the second virtual box, and may determine the rate at which the first virtual box overlaps the second virtual box, by using each region divided at specified intervals, thereby relatively quickly performing computations.

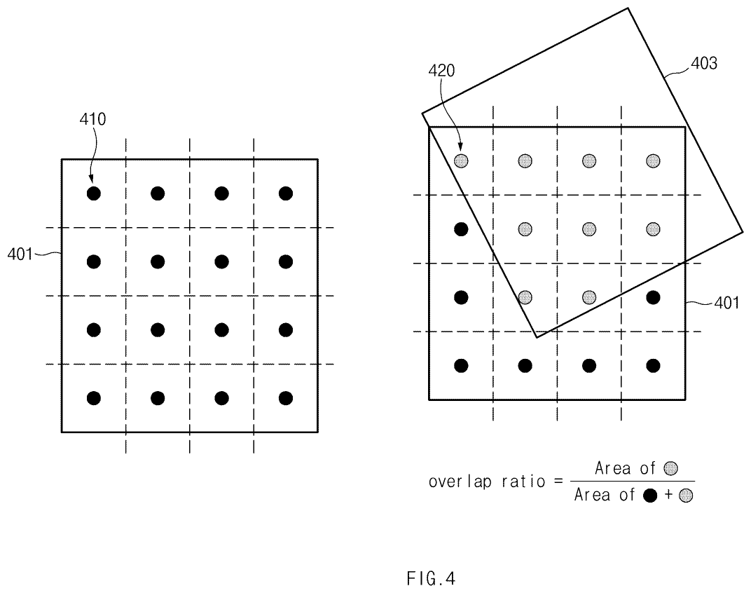

FIG. 4 illustrates an example of identifying an overlap ratio between a first virtual box and a second virtual box, in an example of the present disclosure.

Referring to FIG. 4, a processor (e.g., the processor 110 of FIG. 1) of a vehicle control apparatus (e.g., the vehicle control apparatus 100 of FIG. 1) according to an example may obtain a first virtual box 401 based on a point cloud corresponding to an external object obtained through a LiDAR (e.g., the LiDAR 120 in FIG. 1). The processor may obtain a second virtual box 403 based on inputting the point cloud into a neural network model stored in a memory (e.g., the memory 130 in FIG. 1). The first virtual box 401 and the second virtual box 403 may be examples expressed based on a plane formed by an x-axis and a y-axis among the x-axis, the y-axis, and a z-axis.

For example, the processor may split the first virtual box 401 at specified intervals. The processor may obtain a partial region 410 within the first virtual box 401 based on dividing the width and length of the first virtual box 401 at specified intervals. The partial region 410 of FIG. 4 may include a sample point described in FIG. 3.

In an example, the processor may identify a region 420 where the first virtual box 401 overlaps the second virtual box 403. The processor may identify an overlap ratio between the first virtual box 401 and the second virtual box 403 based on identifying the region 420 where the first virtual box 401 overlaps the second virtual box 403.

For example, the processor may identify at least one of whether the first virtual box 401 overlaps the second virtual box 403, or the overlap ratio between the first virtual box 401 and the second virtual box 403, or any combination thereof based on the center point of the partial region 410.

For example, the processor may identify that the partial region 410 overlaps the second virtual box 403, based on the center point of the partial region 410 overlapping at least part of the second virtual box 403.

As mentioned above, the processor of the vehicle control apparatus according to an example may identify at least one of whether the first virtual box 401 overlaps the second virtual box 403, or the overlap ratio between the first virtual box 401 and the second virtual box 403, or any combination thereof by performing a relatively small number of operations by using IoU.

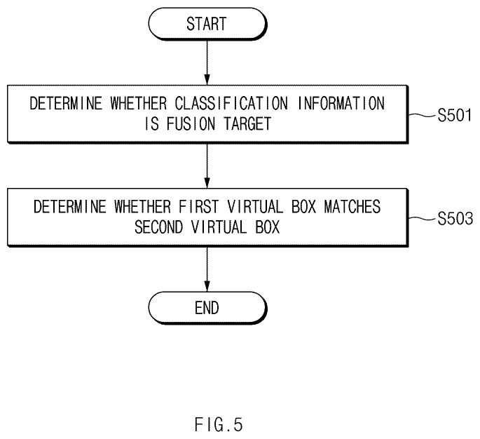

FIG. 5 shows an example of a flowchart associated with a vehicle control method, according to an example of the present disclosure.

Hereinafter, it is assumed that the vehicle control apparatus 100 of FIG. 1 performs the process of FIG. 5. In addition or alternative, in a description of FIG. 5, it may be understood that an operation described as being performed by an apparatus is controlled by the processor 110 of the vehicle control apparatus 100.

At least one of operations of FIG. 5 may be performed by the vehicle control apparatus 100 of FIG. 1. At least one of operations of FIG. 5 may be performed by the processor 110 of FIG. 1. Each of the operations in FIG. 5 may be performed sequentially, but is not necessarily sequentially performed. For example, the order of operations may be changed, and at least two operations may be performed in parallel.

Referring to FIG. 5, in S501, a vehicle control method according to an example may include an operation of determining whether classification information is a fusion target.

For example, the vehicle control method may include an operation of determining whether the classification information is the fusion target, based on whether a specified condition is satisfied.

For example, the specified condition may be associated with whether the first virtual box includes valid information, whether TargetFlag is true, or whether second reliabilities obtained from a second virtual box exceeds a threshold value.

In S503, the vehicle control method according to an example may include an operation of determining whether the first virtual box matches the second virtual box.

For example, the vehicle control method may include an operation of determining whether the first virtual box matches the second virtual box, based on whether the first virtual box overlaps the second virtual box.

For example, the vehicle control method may include an operation of identifying that the first virtual box does not match the second virtual box, based on the first virtual box not overlapping the second virtual box.

For example, the vehicle control method may include an operation of determining whether the first virtual box matches the second virtual box, by using IoU based on identifying that the first virtual box overlaps the second virtual box.

For example, the vehicle control method may include an operation of identifying that the first virtual box matches the second virtual box, based on the fact that the IoU indicating the extent to which the first virtual box overlaps the second virtual box exceeds a reference IoU.

For example, the vehicle control method may include an operation of storing an identifier of the second virtual box matching the first virtual box as well as identifying that the first virtual box matches the second virtual box.

For example, the vehicle control method may include an operation of identifying that the first virtual box does not match the second virtual box, based on the fact that the IoU indicating the extent to which the first virtual box overlaps the second virtual box is smaller than or equal to the reference IoU.

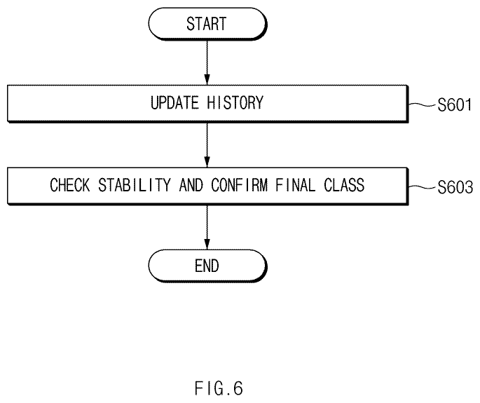

FIG. 6 shows an example of a flowchart associated with a vehicle control method, according to an example of the present disclosure.

Hereinafter, it is assumed that the vehicle control apparatus 100 of FIG. 1 performs the process of FIG. 6. In addition or alternative, in a description of FIG. 6, it may be understood that an operation described as being performed by an apparatus is controlled by the processor 110 of the vehicle control apparatus 100.

At least one of operations of FIG. 6 may be performed by the vehicle control apparatus 100 of FIG. 1. At least one of operations of FIG. 6 may be performed by the processor 110 of FIG. 1. Each of the operations in FIG. 6 may be performed sequentially, but is not necessarily sequentially performed. For example, the order of operations may be changed, and at least two operations may be performed in parallel.

Referring to FIG. 6, in S601, a vehicle control method according to an example may include an operation of updating a history.

For example, the history may include information associated with a first virtual box identified in a plurality of frames. For example, the history may include at least one of a class assigned to the first virtual box output in the plurality of frames, or score information, or any combination thereof.

The vehicle control method according to an example may include an operation of updating a reliability to which the history is reflected. For example, the vehicle control method may include an operation of updating the reliability for each class. For example, the vehicle control method may include an operation of performing normalization such that the sum of reliabilities of all classes is 1.

In S603, the vehicle control method according to an example may include operations of checking stability and confirming a final class.

For example, the vehicle control method may include an operation of identifying the number of times that the class assigned to the first virtual box is changed. For example, the vehicle control method may include an operation of determining whether the class assigned to the first virtual box is changed in the frames before a current time point if the class assigned to the first virtual box is assigned by the class identified through the second virtual box. For example, the vehicle control method may include an operation of reducing the reliability of the first virtual box based on the class assigned to the first virtual box being changed more than the specified number of times (e.g., 3 times, and/or 12 times) in a specified frame (e.g., 5 frames and/or 20 frames).

For example, if the second virtual box is not identified, the vehicle control method may include an operation of determining the class to be assigned to the first virtual box at the current time point based on the class assigned to the first virtual box in the frames before the current time point, and/or a class score.

For example, the vehicle control method may include an operation of determining whether the size of the first virtual box of the current time point satisfies the size of the class assigned to the first virtual box of the current time point.

For example, the vehicle control method may include an operation of reducing the reliability of the first virtual box if the size of the first virtual box of the current time point does not satisfy the size of the class assigned to the first virtual box of the current time point.

For example, the vehicle control method may include an operation of assigning an unknown object and reducing the reliability of the first virtual box, if the class assigned to the first virtual box is a pedestrian, and the length and/or width of the size of the first virtual box is 10 m.

The vehicle control method may include an operation of assigning and outputting a class to the first virtual box by performing the above-described operations.

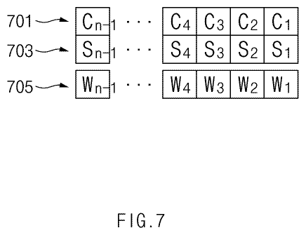

FIG. 7 shows an example of identifying a weight applied to classification information by using a plurality of frames, in an example of the present disclosure.

Referring to FIG. 7, a processor (e.g., the processor 110 of FIG. 1) of a vehicle control apparatus (e.g., the vehicle control apparatus 100 of FIG. 1) according to an example may identify at least one of the class, reliability, or weight, or any combination thereof of a first virtual box, which is output from a plurality of frames obtained at a plurality of time points including a current time point.

A first row 701 of FIG. 7 may include the class of the first virtual box output in the plurality of frames. A second row 703 may include the reliability of the first virtual box output in the plurality of frames. A third row 705 may include the weight applied from the plurality of frames.

$$[ {\sum }_{{c}_{i} = 0} {w}_{i} {c}_{i} {s}_{i} {\sum }_{{c}_{i} = 1} {w}_{i} {c}_{i} {s}_{i} {\sum }_{{c}_{i} = 2} {w}_{i} {c}_{i} {s}_{i} ] \qquad [ Equation 1 ]$$

For example, the processor may obtain “total hist conf” based on Equation 1 described above. For example, in Equation 1, i may denote “n−1” to 1 in FIG. 7. In Equation 1, wᵢ may denote the weight. In Equation 1, cᵢ may denote the class. In Equation 1, sᵢ may denote the score (or reliability).

For example, wᵢ may denote a value greater than wᵢ₋₁. For example, the processor may apply a relatively great weight to a frame relatively close to the current time point.

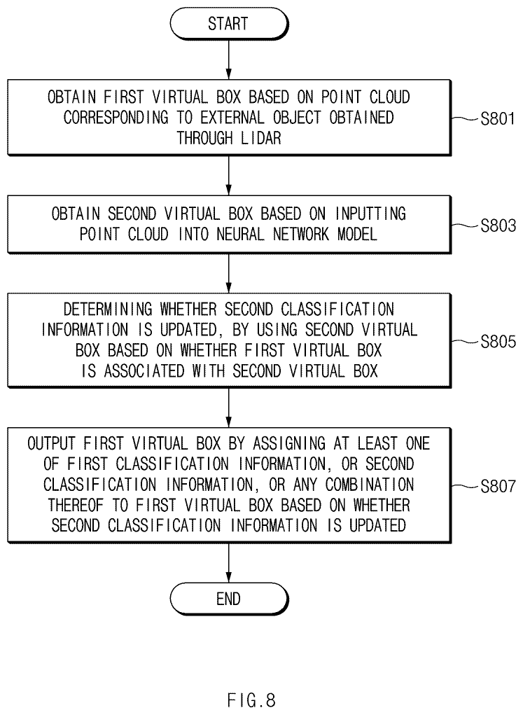

FIG. 8 shows an example of a flowchart associated with a vehicle control method, according to an example of the present disclosure. For convenience, FIG. 8 is described by way of an example in which the steps are performed by a processor (e.g., control circuitry). One, some, or all steps of the example method of FIG. 8, or portions thereof, may be performed by one or more other circuits. One or some, steps of the example method of FIG. 8 may be omitted, performed in other orders, and/or otherwise modified, and/or one or more additional steps may be added.

Hereinafter, it is assumed that the vehicle control apparatus 100 of FIG. 1 performs the process of FIG. 8. In addition or alternative, in a description of FIG. 8, it may be understood that an operation described as being performed by an apparatus is controlled by the processor 110 of the vehicle control apparatus 100.

At least one of operations of FIG. 8 may be performed by the vehicle control apparatus 100 of FIG. 1. At least one of operations of FIG. 8 may be performed by the processor 110 of FIG. 1. Each of the operations in FIG. 8 may be performed sequentially, but is not necessarily sequentially performed. For example, the order of operations may be changed, and at least two operations may be performed in parallel.

Referring to FIG. 8, in S801, a vehicle control method according to an example may include an operation of obtaining a first virtual box based on a point cloud corresponding to an external object obtained through a LiDAR.

For example, the vehicle control method may include an operation of obtaining at least one of the width, length, height, histogram, or density, or any combination thereof of the point cloud from the point cloud.

For example, the vehicle control method may include an operation of obtaining a first virtual box, based on at least one of the width, length, height, histogram, or density, or any combination thereof of the point cloud.

For example, the vehicle control method may include an operation of identifying the width of the point cloud expressed in each layer, within a three-dimensional (3D) virtual space where a point cloud corresponding to the external object is expressed.

For example, the vehicle control method may include an operation of obtaining a histogram based on the point cloud expressed within a 3D virtual space. For example, the vehicle control method may include an operation of obtaining a histogram indicating points, which are accumulated on the z-axis and which are associated with at least one of the x-axis, or the y-axis, or any combination thereof in the 3D virtual space.

For example, the vehicle control method may include an operation of identifying the density of points within the divided region based on dividing the point cloud at specified intervals.

In S803, the vehicle control method according to an example may include an operation of obtaining a second virtual box based on inputting the point cloud into a neural network model.

In S805, the vehicle control method according to an example may include an operation of determining whether second classification information is updated, by using the second virtual box based on whether the first virtual box is associated with the second virtual box.

For example, the vehicle control method may include an operation of updating the second classification information based on identifying that the second classification information is to be updated. The vehicle control method may include an operation of outputting the first virtual box by assigning the updated second classification information to the first virtual box based on updating the second classification information.

For example, the vehicle control method may include an operation of outputting the first virtual box by assigning the first classification information to the first virtual box based on identifying that the second classification information is not to be updated by using the second virtual box.

For example, the vehicle control method may include an operation of determining whether the first virtual box is associated with the second virtual box, based on at least one of whether the flag associated with whether the first virtual box is fused with the second virtual box is true, whether the reliability of the second virtual box exceeds a threshold value, whether the first virtual box overlaps the second virtual box, or whether the overlap ratio between the first virtual box and the second virtual box exceeds a reference ratio, or any combination thereof.

For example, the vehicle control method may include an operation of identifying that the first virtual box is associated with the second virtual box, based on the fact that the flag associated with whether the first virtual box is to be fused with the second virtual box is true, the reliability of the second virtual box exceeds the threshold value, the first virtual box at least partially overlaps the second virtual box, and the overlap ratio between the first virtual box and the second virtual box exceeds the reference ratio.

For example, the vehicle control method may include an operation of identifying that the first virtual box is not associated with the second virtual box based on at least one of the flag associated with whether the first virtual box is to be fused with the second virtual box being false, the reliability of the second virtual box being smaller than or equal to the threshold value, the first virtual box not overlapping the second virtual box, or the overlap ratio between the first virtual box and the second virtual box being smaller than or equal to the reference ratio, or any combination thereof.

For example, the vehicle control method may include an operation of outputting the first virtual box by assigning the first classification information to the second virtual box, based on the first virtual box not being associated with the second virtual box.

According to an example, the vehicle control method may include an operation of identifying at least one of whether the first virtual box overlaps the second virtual box, or the overlap ratio between the first virtual box and the second virtual box, or any combination thereof based on dividing a width and a length of the first virtual box at a specified interval.

In S807, the vehicle control method according to an example may include an operation of outputting the first virtual box by assigning at least one of the first classification information, or the second classification information, or any combination thereof to the first virtual box based on whether the second classification information is updated.

For example, the first classification information may include at least one of first classes indicating types corresponding to the external object identified through the first virtual box among a plurality of predetermined types, or first reliabilities respectively corresponding to the first classes, or any combination thereof.

For example, the second classification information may include at least one of second classes indicating types corresponding to the external object identified through the second virtual box among the plurality of predetermined types, or second reliabilities respectively corresponding to the second classes, or any combination thereof.

According to an example, the vehicle control method may include an operation of changing at least one of a first information reliability of the first classification information, or a second information reliability of the second classification information, or any combination thereof based on the number of times that classification information assigned to the first virtual box is changed, in a plurality of frames including a frame including the point cloud.

According to an example, the vehicle control method may include an operation of changing at least one of a first information reliability of the first classification information, or a second information reliability of the second classification information, or any combination thereof based on the number of times that the first virtual box is associated with the second virtual box, in a plurality of frames including a plurality of frames including the point cloud.

According to an example, the vehicle control method may include an operation of correcting at least one of the first reliabilities, or the second reliabilities, or any combination thereof by performing normalization on at least one of the first reliabilities, or the second reliabilities, or any combination thereof based on a plurality of frames including a frame in which the point cloud is included.

According to an example, the vehicle control method may include an operation of determining a weight to be applied to at least one of the first classification information, or the second classification information, or any combination thereof based on a time point, at which the frame including the point cloud is obtained, in a plurality of frames including a frame including the point cloud.

According to an example, the vehicle control method may include an operation of changing at least one of a first information reliability of the first classification information, or a second information reliability of the second classification information, or any combination thereof based on a size of the first virtual box.

For example, the vehicle control method may include an operation of identifying classification information to be assigned to the first virtual box based on changing at least one of the first information reliability of the first classification information, or the second information reliability of the second classification information, or any combination thereof. For example, the vehicle control method may include an operation of identifying classification information to be assigned to the first virtual box based on changing at least one of the first information reliability of the first classification information, or the second information reliability of the second classification information, or any combination thereof, and outputting the first virtual box by assigning the determined classification information to the first virtual box.

As mentioned above, the vehicle control method according to an example may assign and output classification information indicating the type of an external object to the first virtual box by using various processes, thereby relatively accurately identifying the type of an external object. Moreover, the vehicle control method may assign and output relatively accurate classification information to the first virtual box, thereby improving performance if a vehicle is driven in a driving assistance activation mode or an autonomous driving mode by using the first virtual box.

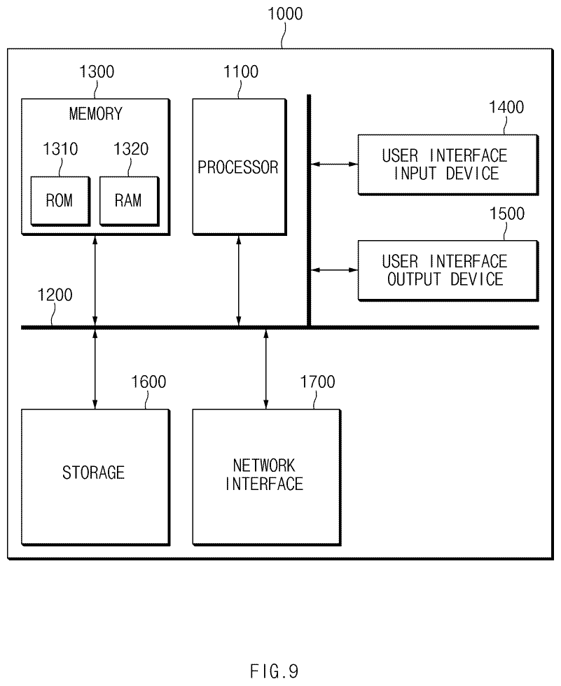

FIG. 9 shows an example of a computing system associated with a vehicle control apparatus or vehicle control method, according to an example of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present disclosure was made to solve the above-mentioned problems occurring in the prior art while advantages achieved by the prior art are maintained intact.

An example of the present disclosure provides a vehicle control apparatus for assigning the type of an external object to a virtual box created by using a point cloud obtained through a LiDAR, and a method thereof.

An example of the present disclosure provides a vehicle control apparatus for determining the type of the external object corresponding to the virtual box by comparing a virtual box generated by signal processing on the point cloud with a virtual box output from a deep learning model, and a method thereof.

An example of the present disclosure provides a vehicle control apparatus for determining the type of the external object by using information of a plurality of frames, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a light detection and ranging (LiDAR), a memory in which a neural network model is stored, and a processor. The processor may obtain a first virtual box based on a point cloud corresponding to an external object obtained through the LiDAR, may obtain a second virtual box based on inputting the point cloud into the neural network model, may initialize second classification information among first classification information and the second classification information included in the first virtual box, may determine whether to update the second classification information, by using the second virtual box based on whether the first virtual box is associated with the second virtual box, may determine whether the second classification information is updated, by using the second virtual box based on whether the first virtual box is associated with the second virtual box, and may output the first virtual box by assigning at least one of the first classification information, or the second classification information, or any combination thereof to the first virtual box based on whether the second classification information is updated.

In an example, the first classification information may include at least one of first classes indicating types corresponding to the external object identified through the first virtual box among a plurality of predetermined types, or first reliabilities respectively corresponding to the first classes, or any combination thereof. The second classification information may include at least one of second classes indicating types corresponding to the external object identified through the second virtual box among the plurality of predetermined types, or second reliabilities respectively corresponding to the second classes, or any combination thereof.

In an example, the processor may update the second classification information based on identifying that the second classification information is to be updated, and may output the first virtual box by assigning the updated second classification information to the first virtual box based on updating the second classification information.

In an example, the processor may output the first virtual box by assigning the first classification information to the first virtual box based on identifying that the second classification information is not to be updated by using the second virtual box.

In an example, the processor may determine whether the first virtual box is associated with the second virtual box, based on at least one of whether a flag associated with whether the first virtual box is fused with the second virtual box is true, whether a box reliability of the second virtual box exceeds a threshold value, whether the first virtual box overlaps the second virtual box, or whether an overlap ratio between the first virtual box and the second virtual box exceeds a reference ratio, or any combination thereof.

In an example, the processor may identify that the first virtual box is associated with the second virtual box, based on a fact that the flag is true, the box reliability of the second virtual box exceeds the threshold value, the first virtual box at least partially overlaps the second virtual box, and the overlap ratio between the first virtual box and the second virtual box exceeds the reference ratio.

In an example, the processor may identify that the first virtual box is not associated with the second virtual box, based on a fact that at least one of the flag is false, the box reliability of the second virtual box is smaller than or equal to the threshold value, the first virtual box does not overlap the second virtual box, or the overlap ratio between the first virtual box and the second virtual box is smaller than or equal to the reference ratio, or any combination thereof, and may output the first virtual box by assigning the first classification information to the first virtual box, based on a fact that the first virtual box is not associated with the second virtual box.

In an example, the processor may identify at least one of whether the first virtual box overlaps the second virtual box, or the overlap ratio between the first virtual box and the second virtual box, or any combination thereof based on dividing a width and a length of the first virtual box at a specified interval.

In an example, the processor may change at least one of a first information reliability of the first classification information, or a second information reliability of the second classification information, or any combination thereof based on a number of times that classification information assigned to the first virtual box is changed, in a plurality of frames including a frame including the point cloud.

In an example, the processor may change at least one of a first information reliability of the first classification information, or a second information reliability of the second classification information, or any combination thereof based on a number of times that the first virtual box is associated with the second virtual box, in a plurality of frames including a frame including the point cloud.

In an example, the processor may correct at least one of the first reliabilities, or the second reliabilities, or any combination thereof by performing normalization on at least one of the first reliabilities, or the second reliabilities, or any combination thereof based on a plurality of frames including a frame including the point cloud.

In an example, the processor may determine a weight to be applied to at least one of the first classification information, or the second classification information, or any combination thereof based on a time point, at which the frame is obtained, in a plurality of frames including a frame including the point cloud.

In an example, the processor may change at least one of a first information reliability of the first classification information, or a second information reliability of the second classification information, or any combination thereof based on a size of the first virtual box.

In an example, the processor may obtain at least one of a width, a length, a height, a histogram, or a density, or any combination thereof of the point cloud from the point cloud, and may obtain the first virtual box based on at least one of the width, the length, the height, the histogram, or the density, or any combination thereof.

According to an example of the present disclosure, a vehicle control method may include obtaining, by a processor, a first virtual box based on a point cloud corresponding to an external object obtained through a LiDAR, obtaining a second virtual box based on inputting the point cloud into a neural network model, initializing second classification information among first classification information and the second classification information included in the first virtual box, determining whether to update the second classification information, by using the second virtual box based on whether the first virtual box is associated with the second virtual box, determining whether the second classification information is updated, by using the second virtual box based on whether the first virtual box is associated with the second virtual box, and outputting the first virtual box by assigning at least one of the first classification information, or the second classification information, or any combination thereof to the first virtual box based on whether the second classification information is updated.

In an example, the first classification information may include at least one of first classes indicating types corresponding to the external object identified through the first virtual box among a plurality of predetermined types, or first reliabilities respectively corresponding to the first classes, or any combination thereof. The second classification information may include at least one of second classes indicating types corresponding to the external object identified through the second virtual box among the plurality of predetermined types, or second reliabilities respectively corresponding to the second classes, or any combination thereof.

According to an example, the vehicle control method may include updating the second classification information based on identifying that the second classification information is to be updated, and outputting the first virtual box by assigning the updated second classification information to the first virtual box based on updating the second classification information.

According to an example, the vehicle control method may include outputting the first virtual box by assigning the first classification information to the first virtual box based on identifying that the second classification information is not to be updated by using the second virtual box.

According to an example, the vehicle control method may include determining whether the first virtual box is associated with the second virtual box, based on at least one of whether a flag associated with whether the first virtual box is fused with the second virtual box is true, whether a box reliability of the second virtual box exceeds a threshold value, whether the first virtual box overlaps the second virtual box, or whether an overlap ratio between the first virtual box and the second virtual box exceeds a reference ratio, or any combination thereof.

According to an example, the vehicle control method may include obtaining at least one of a width, a length, a height, a histogram, or a density, or any combination thereof of the point cloud from the point cloud, and obtaining the first virtual box based on at least one of the width, the length, the height, the histogram, or the density, or any combination thereof.

According to an example, the vehicle control method may include identifying at least one of whether the first virtual box overlaps the second virtual box, or the overlap ratio between the first virtual box and the second virtual box, or any combination thereof based on dividing a width and a length of the first virtual box at a specified interval.

According to an example, the vehicle control method may include change at least one of a first information reliability of the first classification information, or a second information reliability of the second classification information, or any combination thereof based on a number of times that the first virtual box is associated with the second virtual box, in a plurality of frames including a frame including the point cloud.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may assign the type of an external object to a virtual box created by using a point cloud obtained through a LiDAR.

Moreover, the present technology may determine the type of the external object corresponding to the virtual box by comparing a virtual box generated by signal processing on the point cloud with a virtual box output from a deep learning model.

Furthermore, the present technology may determine the type of the external object by using information of a plurality of frames.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a sensor;
a memory configured to store a neural network model; and
a processor configured to:
obtain, based on a cluster of points representing an external object detected by the sensor, a first virtual box;
obtain, based on inputting the cluster of points into the neural network model, a second virtual box;
initialize second classification information among first classification information and the second classification information, wherein the first classification information and the second classification information are included in the first virtual box;
determine, based on whether the first virtual box being associated with the second virtual box, whether to update the second classification information by using the second virtual box;
output, based on whether the second classification information being updated, the first virtual box by assigning at least one of the first classification information or the second classification information to the first virtual box;
generate a signal indicating at least one of the first classification information or the second classification information assigned to the first virtual box; and
control, based on the signal, autonomous driving of the vehicle.

2. The apparatus of claim 1, wherein the first classification information comprises at least one of:
first classes indicating types corresponding to the external object, wherein the external object is determined through the first virtual box, or
first reliabilities respectively corresponding to the first classes, and
wherein the second classification information comprises at least one of:
second classes indicating types corresponding to the external object, wherein the external object is determined through the second virtual box, or
second reliabilities respectively corresponding to the second classes.

3. The apparatus of claim 1, wherein the processor is configured to:
update, based on determining that the second classification information is to be updated, the second classification information; and
output, based on updating the second classification information, the first virtual box by assigning the updated second classification information to the first virtual box.

4. The apparatus of claim 1, wherein the processor is configured to:
output, based on determining that the second classification information is not to be updated by using the second virtual box, the first virtual box by assigning the first classification information to the first virtual box.

5. The apparatus of claim 1, wherein the processor is configured to:
determine whether the first virtual box is associated with the second virtual box, based on at least one of:
an indication of whether the first virtual box is fused with the second virtual box,
an indication of whether a box reliability of the second virtual box satisfies a threshold value, or
an indication of whether the first virtual box overlaps the second virtual box and whether an overlap ratio between the first virtual box and the second virtual box satisfies a reference ratio.

6. The apparatus of claim 5, wherein the processor is configured to:
determine that the first virtual box is associated with the second virtual box, based on at least one of:
the first virtual box being fused with the second virtual box,
the box reliability of the second virtual box satisfying the threshold value, or
the first virtual box at least partially overlapping the second virtual box and the overlap ratio between the first virtual box and the second virtual box satisfying the reference ratio.

7. The apparatus of claim 5, wherein the processor is configured to:
determine that the first virtual box is not associated with the second virtual box, based on least one of:
the first virtual box not being fused with the second virtual box,
the box reliability of the second virtual box not satisfying the threshold value,
the first virtual box not overlapping the second virtual box, or
the overlap ratio between the first virtual box and the second virtual box not satisfying the reference ratio; and
output, based on the first virtual box not being associated with the second virtual box, the first virtual box by assigning the first classification information to the first virtual box.

8. The apparatus of claim 5, wherein the processor is configured to:
determine, based on dividing a width and a length of the first virtual box at an interval, at least one of:
whether the first virtual box overlaps the second virtual box, or
the overlap ratio between the first virtual box and the second virtual box.

9. The apparatus of claim 1, wherein the processor is configured to:
change, based on a number of times that the first classification information assigned to the first virtual box is changed, in a plurality of frames including a frame including the cluster of points, a first information reliability of the first classification information; and
change, based on a number of times that the second classification information assigned to the first virtual box is changed, in the plurality of frames, a second information reliability of the second classification information.

10. The apparatus of claim 1, wherein the processor is configured to:
change, based on a number of times that the first virtual box is associated with the second virtual box, in a plurality of frames including a frame including the cluster of points, at least one of a first information reliability of the first classification information or a second information reliability of the second classification information.

11. The apparatus of claim 2, wherein the processor is configured to:
adjust, based on a plurality of frames including a frame including the cluster of points, at least one of the first reliabilities or the second reliabilities by performing normalization on at least one of the first reliabilities or the second reliabilities.

12. The apparatus of claim 1, wherein the processor is configured to:
determine a weight based on a time point at which a frame is obtained, in a plurality of frames including the frame, wherein the frame comprises the cluster of points, and wherein the weight is to be applied to at least one of the first classification information or the second classification information.

13. The apparatus of claim 1, wherein the processor is configured to:
change, based on a size of the first virtual box, at least one of a first information reliability of the first classification information or a second information reliability of the second classification information.

14. The apparatus of claim 1, wherein the processor is configured to:
obtain, from the cluster of points, at least one of a width, a length, a height, a histogram, or a density of the cluster of points; and
obtain, based on at least one of the width, the length, the height, the histogram, or the density, the first virtual box.

15. A method performed by an apparatus of a vehicle for controlling autonomous driving of the vehicle, the method comprising:
obtaining, based on a cluster of points representing an external object detected by a sensor, a first virtual box;
obtaining, based on inputting the cluster of points into a neural network model, a second virtual box;
initializing second classification information among first classification information and the second classification information, wherein the first classification information and the second classification information are included in the first virtual box;
determining, based on whether the first virtual box being associated with the second virtual box, whether to update the second classification information by using the second virtual box;
outputting, based on whether the second classification information being updated, the first virtual box by assigning at least one of the first classification information or the second classification information to the first virtual box;
generating a signal indicating at least one of the first classification information or the second classification information assigned to the first virtual box; and
controlling, based on the signal, autonomous driving of the vehicle.

16. The method of claim 15, wherein the first classification information comprises at least one of:
first classes indicating types corresponding to the external object, wherein the external object is determined through the first virtual box, or
first reliabilities respectively corresponding to the first classes, and
wherein the second classification information comprises at least one of:
second classes indicating types corresponding to the external object, wherein the external object is determined through the second virtual box, or
second reliabilities respectively corresponding to the second classes.

17. The method of claim 15, further comprising:
updating, based on determining whether the second classification information is to be updated, the second classification information; and
performing one of:
outputting, based on updating the second classification information, the first virtual box by assigning the updated second classification information to the first virtual box; or
outputting the first virtual box by assigning the first classification information to the first virtual box.

18. The method of claim 15, wherein the outputting the first virtual box by assigning the first classification information to the first virtual box is based on determining that the second classification information is not to be updated by using the second virtual box.

19. The method of claim 15, further comprising:
determining whether the first virtual box is associated with the second virtual box, based on at least one of:
an indication of whether the first virtual box is fused with the second virtual box,
an indication of whether a box reliability of the second virtual box satisfies a threshold value, or
an indication of whether the first virtual box overlaps the second virtual box and whether an overlap ratio between the first virtual box and the second virtual box satisfies a reference ratio.

20. The method of claim 15, further comprising:
obtaining, from the cluster of points, at least one of a width, a length, a height, a histogram, or a density of the cluster of points; and
obtaining, based on at least one of the width, the length, the height, the histogram, or the density, the first virtual box.
